(19) United States
(12) Patent Application Publication
(10) Pub. No.: US 2013/0186758 A1
(43) Pub. Date: Jul. 25, 2013

(54) CURRENT-CARRYING NANOWIRE HAVING A NANOPORE FOR HIGH-SENSITIVITY DETECTION AND ANALYSIS OF BIOMOLECULES

(71) Applicants: The Trustees Of The University Of Pennsylvania, Philadelphia, PA (US); University Of Delaware, Newark, DE (US)

(72) Inventors: Kamal K. SAHA, Newark, DE (US); Branislav K. NIKOLIC, North East, MD (US); Marija DRNDIC, Philadelphia, PA (US)

(73) Assignees: University Of Delaware, Newark, DE (US); The Trustees Of The University Of Pennsylvania, Philadelphia, PA (US)

(21) Appl. No.: 13/706,060

(22) Filed: Dec. 5, 2012

Related U.S. Application Data
(60) Provisional application No. 61/568,673, filed on Dec. 9, 2011.

(51) Int. Cl. G01N 27/447

(52) U.S. Cl. CPC G01N 27/44791; G01N 27/447
USPC 204/452; 204/603

(57) ABSTRACT

Disclosed are devices that feature nanopores formed in graphene sheets, such as graphene ribbons. The graphene sheets include an edge irregularity, such as a zig-zag configuration, a chiral edge, or an armchair-configuration edge, which edges confer on the devices the ability to discriminate between different subunits of a macromolecule translocated through the nanpore. The disclosed devices and methods have application to DNA sequencing and analysis, among other applications.

### RELATED APPLICATION

The present application claims priority to U.S. patent application 61/568,673, “Polymer Analysis Device Featuring Contoured Graphene Materials,” filed Dec. 9, 2011, the entirety of which application is incorporated herein by reference for all purposes.

### STATEMENT OF GOVERNMENT RIGHTS

This work was supported by Department of Energy Grant DE-FG02-07ER46374, by National Institutes of Health Grants R21HG004767 and R21HG006313, and by National Science Foundation grant TG-DMR100002.

### TECHNICAL FIELD

The present disclosure relates to the fields of solid-state nanopore devices and to the field of DNA sequencing.

### BACKGROUND

Several proposals have been developed to address rapid DNA sequencing by treading a biomolecule through a nanogap between functionalized metallic (e.g., gold) electrodes. In such devices, interaction between the DNA molecule and the functional group of the electrodes is expected to orient the DNA bases to create a reproducible tunneling current between the electrodes. The Fermi energy of metallic gold electrodes is, however, far removed from the molecular eigenlevels (energy levels) of DNA bases, so that transport is governed by nonresonant tunneling which mostly depends on the difficult-to-control molecule-electrode geometry.

Keeping the bias voltage low in order to avoid forces on the negatively charged backbone of DNA (which could move DNA toward one of the electrodes and thereby impede its translocation), leads to very small tunneling currents, which in turn leads to poor signal to noise ratio. This poor ratio poses challenges to achieving sufficient measurement resolution to detect and identify individual DNA bases. Accordingly, there is a need in the art for improved devices and methods for DNA analysis (and other polymer sequencing).

### SUMMARY

In meeting the long-felt needs described above, the present disclosure first provides devices, the devices suitably comprising a first graphene sheet having a first pore formed therethrough, the first graphene sheet having an edge at a distance from the first pore, the edge including at least one non-linear portion, and the first graphene sheet being in electronic communication with at least two electrodes.

Also provided are methods, the methods including translocating at least a portion of a macromolecule through a first pore formed in a graphene sheet, at least one atom of the first pore being passivated with a first passivating atom, the graphene sheet having an edge at a distance from the first pore, the edge including at least one non-linear portion; collecting at least one signal related to the translocation of the at least a portion of the macromolecule through the first pore.

Further provided are devices, the devices including a first graphene sheet having a first pore formed therethrough, the first graphene sheet having an edge that comprises chiral graphene, armchair graphene, or both, the edge at a distance from the first pore, and the first graphene sheet being in electronic communication with at least two electrodes.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale or proportion. In the drawings:

FIG. 1: Schematic view of the proposed two-terminal device where transverse conduction current flows around the zigzag edges of a metallic graphene nanoribbon with a nanopore, while DNA molecule is translocated through the pore to induce nucleobase-specific-modulation of such edge currents. The active device region, which is simulated via first-principles quantum transport formalism, consists of a segment of 14-ZGNR (composed of 14-zigzag chains which determine its width 3.1 nm) and a nanopore of 1.2 nm diameter. The edge carbon atoms of the nanopore are passivated by either hydrogen or nitrogen, while edge atoms of ZGNR itself are passivated by hydrogen. The total number of simulated atoms in the active region, including the nucleobase within the nanopore, is around 700.

FIG. 2: (a) The room-temperature conductance of the two-terminal 14-ZGNRs with 1.2 nm diameter nanopore whose edge carbon atoms are passivated by either hydrogen (H-pore) or nitrogen (N-pore). (b) The room-temperature conductance of the same device as in panel (a) when one of the four nucleobases (A-adenine, C-cytosine, G-guanine, T-thymine) is inserted into the center of the nanopore within the yz-plane [FIG. 3(e)]. These conductances are computed via first-principles quantum transport simulations where both panels compare results obtained using two different NEGF-DFT codes—a MT-NEGF-DFT code and a commercial ATK.

FIG. 3: (a) The variation of the room-temperature conductance of 14-ZGNR with N-pore due to the rotation of A, C, G, T nucleobases within the nanopore. The shaded vertical rectangles mark the regions of overlap between the conductance intervals associated with different nucleobases. The specific positions of a nucleobase (guanine in the example) within the N-pore that define the conductance intervals shown in panel (a) are illustrated in [see coordinate system in FIG. 1]: (b) nucleobase within the xy-plane (hosting also ZGNR and nanopore); (c) nucleobase within the plane inclined at an angle of 45° with respect to the xy-plane; (d) nucleobase within the xz-plane; (e) nucleobase within the yz-plane. The conductances in panel (a) were computed using a MT-NEGF-DFT code. 19,20

FIG. 4: The zero-bias electronic transmission function Eq. (1) for an infinite homogeneous 14-ZGNR, whose edge carbon atoms are passivated by hydrogen, and the same nanoribbon with empty H-pore or N-pore of diameter ≈1.2 nm (see FIG. 1) drilled in its interior.

FIG. 5: The self-consistent Hartree potential at zero bias voltage for the active region of 14-ZGNR biosensors (FIG. 1) with: (a) empty H-pore; (b) H-pore with cytosine positioned in its center within the yz-plane [FIG. 3(e)]; (c) empty N-pore; and (d) N-pore with thymine positioned in its center within the yz-plane [FIG. 3(e)].

FIG. 6: Current-voltage characteristics of 14-ZGNR with N-pore which is empty (dashed line) or contains guanine (solid line) in its center placed within the yz-plane [FIG. 3(e)]. The current at finite bias voltage is computed using a MT-NEGF-DFT code.

FIG. 7. The room temperature conductance of the two-terminal 14-ZGNRs with ≈1.2 nm diameter N-pore which is empty, or contains isolated neutral phosphate or sugar group. All dangling bonds in the illustration of these two groups in the insets have been terminated with hydrogen atoms.

FIG. 8. Comparison of the room temperature conductance (open squares) presented in FIG. 2(b) for DNA nucleobases inserted into the N-pore [within the yz-plane, see FIG. 1 and FIG. 3(e)] to the conductance (filled squares) of the nucleobases in the same orientation with respect to the nanpore after they are attached to sugar-phosphate backbone.

FIG. 9. Change in the room temperature conductance of ZGNR+N-pore device caused by the Adenine nucleobase moving along the perpendicular direction (z-axis in FIG. 1). The insets illustrate three (out of seven) investigated positions of Adenine which is translated both above and below the nanopore while remaining within the yz-plane (see FIG. 1). The asymmetry in the conductance trace is due to the asymmetry of the structure of Adenine molecule.

FIG. 10 illustrates current patterns for graphene ribbons having zig-zag edges and also having chiral edges; the current is shown by summing up all arrows to obtain conventional total current as the number of electrons passing through a cross section per second; this local current is a conduction current that flows along the edge in both cases and is not affected nanopore formation.

FIG. 11 illustrates non-limiting, illustrative dimensions for pores formed in graphene sheets having (a) zig-zag and (b) chiral edge configurations.

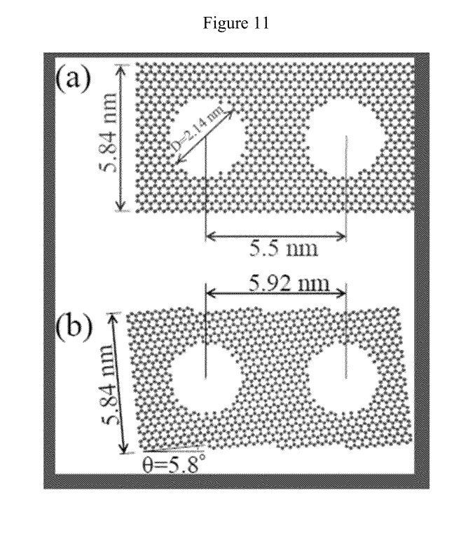

FIG. 12 illustrates a current profile over a cross-section of an exemplary device.

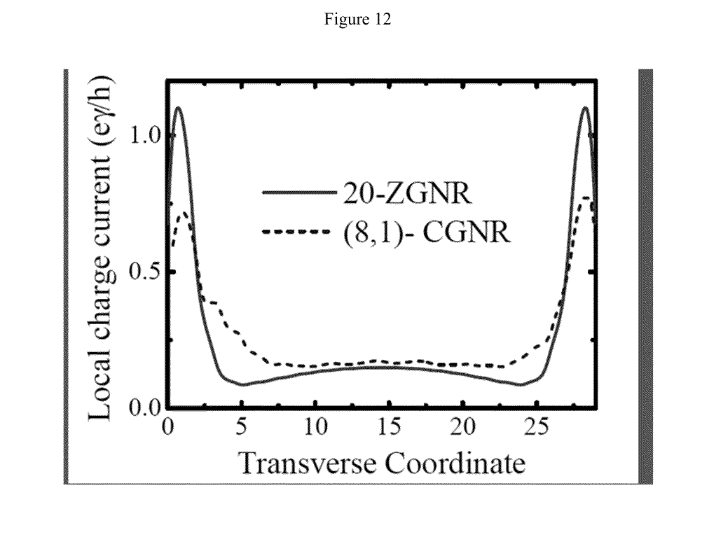

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “approximately” or “about,” it will be understood that the particular value forms another embodiment. All ranges are inclusive and combinable, and all publications cited herein are incorporated by reference in their entireties for any and all purposes.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range. Documents mentioned herein are incorporated in their entireties for any and all purposes.

In a first aspect, the present disclosure provides analytic devices. These devices include a first graphene sheet having a first pore formed therethrough, the first graphene sheet having an edge at a distance from the first pore, the edge including at least one non-linear portion, and the first graphene sheet being in electronic communication with at least two electrodes.

In some embodiments, at least one atom of the first pore of the first graphene sheet is passivated with a first passivating atom capable of an electronic interaction with a nucleotide base. Such passivants include hydrogen, nitrogen, or any combination thereof.

The graphene sheet suitably has a single-atom thickness, although thicker graphene sheets are suitable. The graphene sheet may be in the form of a so-called ribbon, with an aspect ratio of more than 1. The width of such ribbons may be in the range of about 2 nm, about 5 nm, about 10 nm, about 50 nm, or even about 100 or 500 nm. Wider sheets may of course be used.

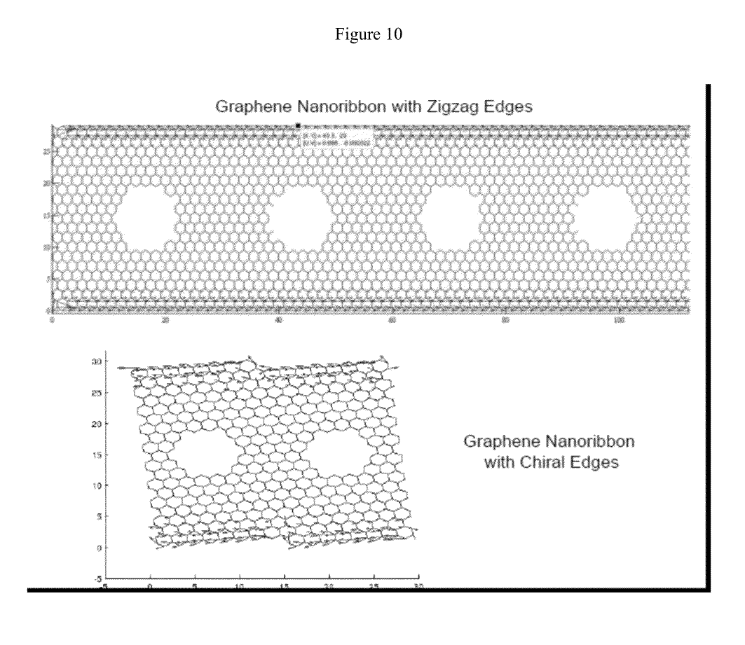

The non-linear portion of the edge of the graphene sheet may comprise, for example, one or more irregularities. The edge may, for example, include an indentation, a cut-out, or any combination thereof. In some particularly suitable embodiments, the non-linear portion is characterized as zig-zagged in configuration. This is shown by exemplary FIG. 10. Alternatively, as described elsewhere herein, the graphene sheet may comprise a chiral edge. The graphene sheet may have an edge that has a so-called “armchair” configuration.

The edge of the sheet may be located at least one atom away from an edge of the first pore, or at least 5 atoms away from the first pore. The sheet edge may be located from between 1 to about 1,000,000 atoms from the edge of the first pore, in some embodiments.

In particularly suitable embodiments, a macromolecule is translocated through the nanopore in a direction perpendicular to the graphene sheet, such that the macromolecule interacts with local transverse currents injected through the electrodes and that flow along the graphene nanoribbon edges. These transverse currents are suitably measured by the device.

The electrodes of the disclosed devices are suitably configured to drive a current transverse to the first graphene sheet. At least one of the electrodes may be in electronic communication with a current monitor, a voltage monitor, or both, as described in the illustrative examples. The devices suitably also include a voltage source capable of applying a voltage in the range of from 0.05 to about 1 V between the electrodes.

The first pore of the devices suitably places two reservoirs in fluid communication with one another. The reservoirs may be filled with a fluid or other medium. One or more of the reservoirs may contain a sample, such as DNA, RNA, or other macromolecules to be studied. The devices may also include heaters (e.g., electrical, magnetic, or other heaters) that supply heat to the first graphene sheet. The devices may also include a refrigeration system or other device capable of removing heat from the first graphene sheet.

In some embodiments, the devices include a second pore that is formed in the first graphene sheet. The first and second pores may have a cross-sectional dimension (e.g., radius or diameter) in the range of from about 0.5 nm to about 10 nm, or to about 20 nm, about 50 nm, or even about 100 nm or even about 500 nm. The nanopores may suitably have a diameter greater than about 0.5 nm. The first and second pores may have the same or different cross-sectional dimensions. One or more atoms that define the second pore may be passivated; hydrogen, nitrogen, and the like are considered suitable passivants. The first and second pores may be passivated with different passivating atoms. In this way, devices are constructed that feature pores that are capable of interacting differently with DNA molecules or other samples.

The devices may also include a second graphene sheet having a second pore formed therethrough. It is considered suitable for at least one atom of the edge defining the second pore to be passivated with hydrogen, nitrogen, and the like.

The devices are suitably configured to collect one or more signals related to the passage of at least a portion of a macromolecule through the first pore. The macromolecule may be driven through the pore by application of a gradient, such as a pressure gradient, an electrical gradient, or even an ionic or other chemical gradient. The devices may also be configured to collect a signal related to passage of at least a portion of a macromolecule through the second pore. A second pore may be formed, in some embodiments, in a second graphene sheet. Such devices are suitably configured such that a user may collect a signal related to the passage of a macromolecule through the second pore.

Also disclosed are methods. These methods suitably include translocating at least a portion of a macromolecule through a first pore formed in a graphene sheet, with at least one atom of the first pore being passivated with a first passivating atom, the graphene sheet having an edge at a distance from the first pore, the edge including at least one non-linear portion. The user may collect at least one signal related to the translocation of the at least a portion of the macromolecule through the first pore.

Translocation may be effected by application of a voltage gradient, as described elsewhere herein.

A variety of macromolecules may be used. Polynucleotides (such as DNA) are considered especially suitable for the disclosed methods. RNA, mRNA, and the like are all considered suitable for these disclosed methods.

The collected signal may be related to an interaction between a base of the polynucleotide and a passivating atom of the first pore. Such an interaction may be electrical in nature, as described elsewhere herein.

The user may further translocate at least a portion of a macromolecule through a second pore formed in the graphene sheet and collecting a signal related to the translocation of the at least a portion of the macromolecule through the second pore. The second pore may be passivated with an atom that differs from the atom that passivates the first pore. A user may also translocate at least a portion of a macromolecule through a second pore formed in a second graphene sheet and collecting a signal related to the translocation of the at least a portion of the macromolecule through the second pore. The second graphene sheet suitably comprises an edge at a distance from the first pore, the edge including at least one non-linear portion, as described elsewhere herein. The second sheet may also have an edge that is chiral.

Also provided are analytic devices. These devices suitably include a first graphene sheet having a first pore formed therethrough, with the first graphene sheet having an edge that comprises chiral graphene, the edge at a distance from the first pore, and the first graphene sheet being in electronic communication with at least two electrodes.

Realizing effective methods for reading the sequence of DNA bases is hoped to lead to personalized medicine and applications in various subfields of genetics. Solid-state nanopores represent one approach of this so-called third-generation sequencing To date, however, ongoing challenges include slowing down the translocation speed of DNA through the nanopores and also achieving single-base resolution.

Included in the present disclosure are devices and methods that address these long-felt needs in the field by adopting an alternative approach that reduces or even minimizes the use of small-tunneling current. In some embodiments, these devices operate using metallic nanowires in which the spatial current profile is confined around their transverse edges, such that forming a nanopore in the substrate does not change significantly their conductance which is of the order of few conductance quanta 2e²/h. The edge (whether zig-zag, chiral, armchair, or otherwise irregular) may be 1, 2, 5, 10, 20, 50, or even 100 atoms from the edge of the nanopore. The graphene edge may also be 1, 10, 25, 50, 100, or even 500 nm from the edge of the pore. The presence of the graphene edge, at virtually any distance from the pore, may give rise to the favorable characteristics described herein.

When one of the four nucleobases of DNA—adenine (A), cytosine (C), guanine (G), or thiamine (T)—is inserted into the nanopore in the course of DNA translocation, the presence of that base affects the charge density around the pore thereby modulating edge conduction currents that are several orders of magnitude larger than tunneling currents across nanogaps or nanopores in graphene having an armchair edge (AGNRs), in which edge currents are absent.

The comparatively large operating current also reduces the need to slow down or constrain the DNA molecule (or other polymer) as the sample translocates, as the measurement speed may be high enough to prevent Brownian fluctuations of the molecule from blurring the signal.

The candidate nanowires supporting edge currents can be found on graphene nanoribbons (GNRs) with zigzag edges, or also on chiral GNRs, as well as among two-dimensional topological insulators. In the case of zigzag or chiral GNRs, spatial profile of local currents carried by electrons around the charge neutral point (CNP) shows large magnitude around the edge and a tiny current flowing through their interior. In 2D Ti nanowires, a similar situation will appear if the wire is narrow enough that helical edge states overlap slightly and edge currents can be modulated. Otherwise, in sufficiently wide 2D TI wires, current is strictly confined to the edges and cannot be affected by time-reversal-preserving impurities, vacancies or modulation of charge density because of the fact that helical edge states guide electrons of opposite spin in op-posite directions to prevent their backscattering. GNRs may be converted into 2D Ti wires via heavy adatom deposition in order to increase the spin-orbit coupling.

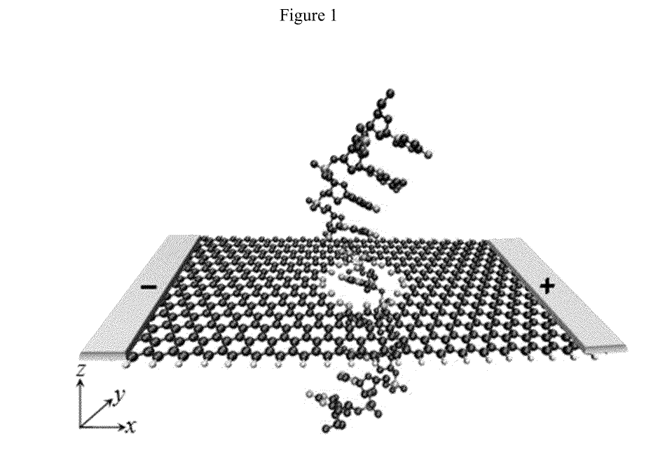

GNRs are known in the art, and their exposed surface allows for an easier integration into biosensors. The exemplary device in FIG. 1 illustrates a GNR with zigzag edges. Note that edge currents in ZGNRs may be exploited to increase heat dissipation around edge defects and, thereby, rearrange atomic structure locally until sharply defined zigzag edge is achieved.

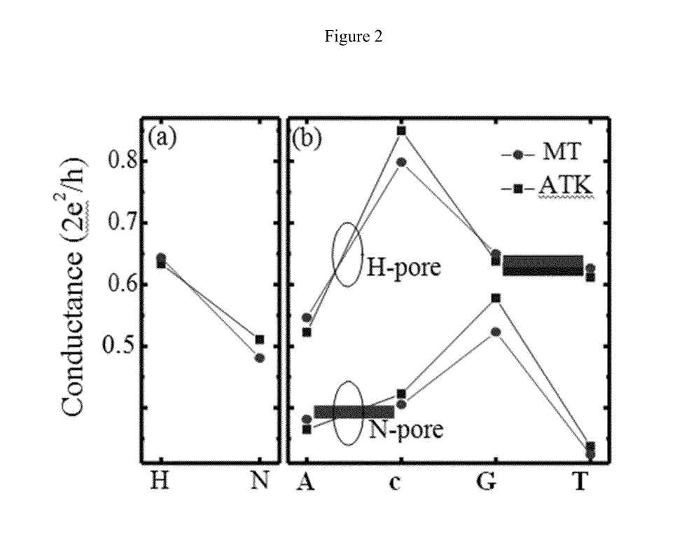

A ZGNR-based device corroborates the general modulation-of-edge-currents concept discussed above, as demonstrated by the central result shown in FIG. 2 obtained via first-principles quantum transport simulations using two completely different computational implementations of the nonequilibrium Green function coupled to density functional theory (NEGF-DFT) formalism.

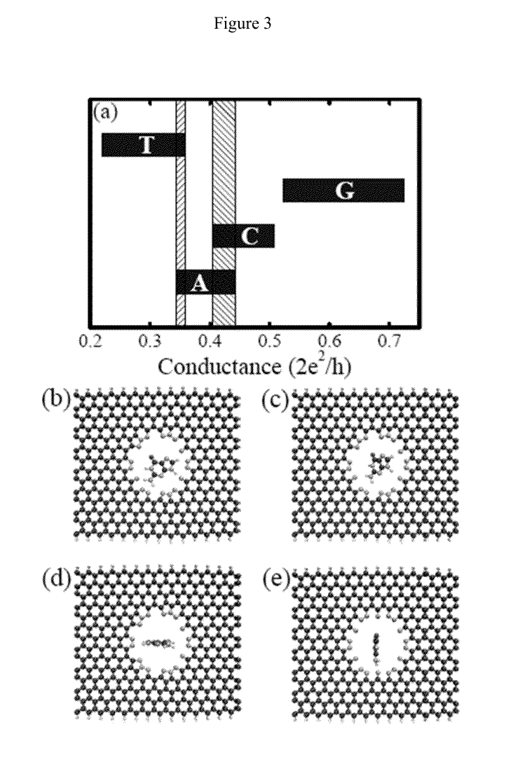

FIG. 2 shows how each nucleobase inserted into the center of the nanopore [within the yz-plane, see FIG. 3(e)] may change the device room-temperature conductance by a specific amount. When spatial orientation of nucleobases with respect to the pore is changed as in FIG. 3(b)-(d), the conductance may vary within the intervals shown in FIG. 3(a). The DNA base-specific modulation of current I is achieved while remaining in the linear-response regime, where I=GV is of the order of μ A at bias voltage appx. 0.1 V. Such sizable operating current is expected to be much larger than electronic noise caused by ionic currents and structure fluctuations of DNA during the translocation process.

In the NEGF-DFT formalism, the Hamiltonian is not known in advance and has to be computed by finding the converged spatial profile of charge via the self-consistent DFT loop for the density matrix ρ=1/(2πi)∫dE G<(E) whose diagonal elements give charge density. he NEGF formalism for steady-state transport operates with two central quantities, retarded G(E) and lesser Green functions G<(E), which describe the density of available quantum states and how electrons occupy those states, respectively. In the coherent transport regime (i.e., in the absence of electron-phonon or electron-electron dephasing processes), only the retarded Green function is required to post-process the result of the DFT loop by expressing the zero-bias electron transmission function between the left (L) and the right (R) electrodes as:

[symbol]

(E)=Tr{Γ_{R}(E)G(E)Γ_{L}(E)G†(E)}. (1)

The matrices ΓL,R(E)=i[ΣL,R(E)−Σ†(E)] account for the level broadening due to the coupling to the electrodes, where ΣL,R(E) are the self-energies introduced by the ZGNR electrodes. 31 The retarded Green function matrix of the active device region is given by G=[E S−H−ΣL−ΣR]−1, where in the local orbital basis {φi} Hamiltonian matrix H is composed of elements Hi j=(φi|ĤKS|φj) and ĤKS is the effective Kohn-Sham Hamiltonian obtained from the DFT self-consistent loop. The overlap matrix S has elements Si j=(φi|φj).

The conductance at finite temperature T is obtained from the transmission function T (E) using the standard Landauer formula for two-terminal devices

$$G = \frac{2 {e}^{2}}{h} {\int }_{- ∞}^{+ ∞} d E 𝒥 ( E ) ( - \frac{\partial f}{\partial E} ) ,$$

where f(E)={1+exp[(E−μ)/kBT]}−1 is the Fermi function of the macroscopic reservoirs into which semi-infinite ideal leads terminate. The electrochemical potential μ is the same for both reservoirs at vanishingly small bias voltage.

The retarded Green function G is computed for the active region of the biosensor shown in FIG. 1 consisting of around 700 atoms. This active region is attached to two semi-infinite ZGNRs electrodes of the same width. As graphene is mechanically strong, it can be used as both the membrane material arrying nanopore and the electrode material. In real devices, ZGNR electrodes will eventually need to be connected to metallic electrodes attached to an external battery. The fact that GNRs used in experiments are typically rather long and screening takes place over a distance shorter than the active region justifies the use of semi-infinite ZGNRs as two electrodes in the simulations.

The edge carbon atoms catch any bond partner they can possibly get to saturate their dangling bonds. ZGNR edges may be are passivated by hydrogen, while edge atoms of the nanopore can be bonded covalently to either hydrogen (H-pore) or nitrogen (N-pore), although other passivants are also suitable. Prior to transport calculations, one may use DFT to relax the coordinates of all atoms within finite-ZGNR+nanopore or finite-ZGNR+nanopore+nucleobase until the forces on individual atoms are minimized to be smaller than 0.05 eV/Å2. The converged result of this procedure is illustrated in FIG. 3(b)-(d) which figure shows how carbon and hydrogen atoms around the nanopore move away from it so that the edge of ZGNR acquires a slight curvature.

Early theoretical studies of ZGNR-based devices have utilized a simplistic tight-binding model with single π orbital per site and nearest neighbor hopping only, or its long-wavelength (continuum) approximation—the Dirac-Weyl Hamiltonian—valid close to CNP. Making connections to realistic device applications may benefit from taking into account charge transfer between different atoms that can be used to passivate edges or chemically functionalize graphene, as well as the charge redistribution when finite bias voltage is applied. As one example, the tight-binding model with the nearest-neighbor hopping predicts incorrectly that zero-temperature conductance of an infinite homogeneous ZGNR is G=2e²/h around the CNP and that current density profile is peaked in the middle of ZGNR despite local density of states reaching maximum around the edges.

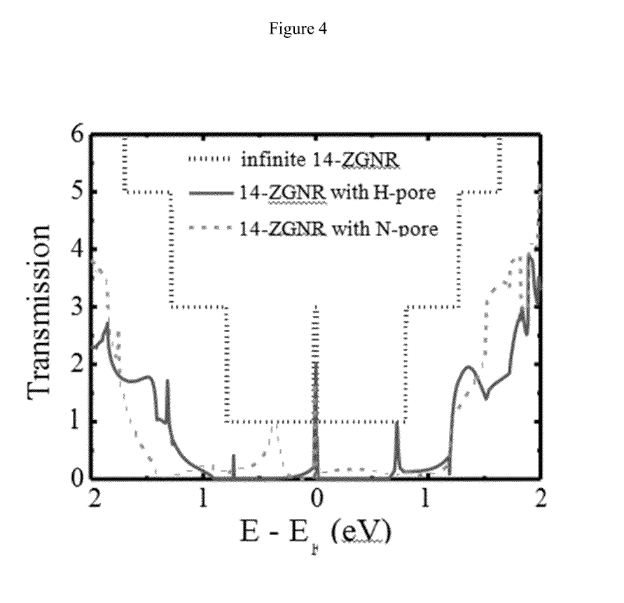

Alternatively, first-principles methods find that the zero-temperature conductance of an infinite homogeneous ZGNR is G=6e²/h around the CNP while local current is confined to flow mostly around the zigzag edges. This is illustrated by quantized steps in the transmission function in FIG. 4 where T=3 around the Fermi energy E−EF=0, and the zero-temperature conductance is given by the simplified version of Eq. (2), G=2e²T (E). In the absence of any nucleobase, the transmission function T (E) plotted in FIG. 4 remains large, with the transmission function being about 2 around CNP E−EF=0 for an infinite ZGNR with either H-pore or N-pore. Without being bound to any single theory, this finding confirms the proposal that a nanopore in the interior of a ZGNR is not able to substantially modify the current flow inherited from a homogeneous nanoribbon since the local current density is mostly confined around the edges for electrons injected at energies sufficiently close to CNP (E−EF=0). Using spin-unrestricted DFT reveals the presence of edge magnetic ordering and the corresponding band gap opening in ZGNRs which, however, is easily destroyed at room temperature so that for realistic device operation ZGNRs can be considered to be metallic.

The change in the room-temperature conductance of empty nanopores in FIG. 2(a) and nanopores with inserted nucleobase in FIG. 2(b) is more pronounced when the pore is terminated with nitrogen. As discussed elsewhere herein, the granphene nanoribbon itself (i.e., exclusive of nanopores) suitably has a zigzag or otherwise irregular edge. The configuration of the of the pore can vary. Nitrogen passivation (as mentioned elsewhere herein) may improve the resolution of the devices (see FIG. 2), but is not required. Suitably, the edge atoms of the grapheme (including pore edge atoms and grapheme sheet/ribbon edge atoms) are passivated with some type of atom or atoms, including hydrogen atoms. Since reliability of predictions of NEGF-DFT simulations requires careful selection of the basis set and pseudopotentials in the DFT part of the calculation, FIG. 2 plots conduc-tances obtained using two different computational implementations of the NEGF-DFT formalism. One analysis method with MT-NEGF-DFT code 19,20 utilizes ultrasoft pseudopotentials and Perdew-Burke-Ernzerhof (PBE) parametrization of the generalized gradient approximation (GGA) for exchange-correlation functional of DFT. The localized basis set is constructed from atom-centered orbitals (six per C atom, four per H atom, 8 per N atom, and 8 per O atom) that are optimized variationally (atomic radius 8.0 Bohr) for the electrodes and the active region separately while their electronic structure is obtained concurrently. For comparison, one may use commercial ATK code where pseudoatomic local orbitals are single-zeta polarized on C and H atoms and double-zeta polarized on N and O atoms (as well as on P atoms). In the case of ATK, one may use Troullier-Martins norm-conserving pseudopotentials, Perdew-Zunger (PZ) parametrization of the local density approximation (LDA) for the exchange-correlation functional of DFT, and energy mesh cutoff for the real-space grid is 65.0 Hartree. FIG. 2 emphasizes that both first-principles quantum transport simulations yield very similar results for the conductance.

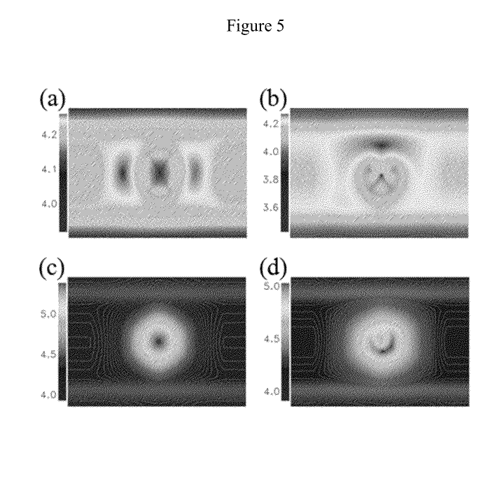

As one, exemplary depiction of the mechanisms by which nucleobases modulate charge transport in a ZGNR with a nanopore, FIG. 5 plots the self-consistent Hartree potential within the central region of a biosensor at zero bias voltage obtained by solving the Poisson equation with the boundary conditions that match the electrostatic potentials of two attached ZGNR electrodes. One may see there is a substantial difference in this potential when switching from an empty pore to a nanopore containing a nucleobase. In the examples in FIG. 5, cytosine is inserted into the H-pore and thymine into the N-pore. These are the cases for which there is the largest change in conductance in FIG. 2 when compared to the corresponding empty nanopores.

One aspect of the uniqueness of the conductance modulation signal associated with each nucleobase is to examine how such signal gets modified when varying the orientation of DNA bases with respect to the nanopore. For selected orientations shown in FIG. 3(b)-(e), the conductance variations for all four nucleobases are plotted in FIG. 3(a).

Biosensors may include a substrate underneath the graphene (e.g., SiO₂ or Si₃N₄). Alternatively, the ribbon may be partially suspended across a small slit in the substrate while still separating two solution chambers. The sensor may also include a solvent or other fluid, DNA counterions, and also fluctuations in the structure of DNA. Using molecular dynamics (MD) simulations to obtain snapshots of translocated DNA within the pore in the presence of solvent and substrate makes it possible to provide real-time atomic coordinates (of the nucleobases, water and ions) into NEGF-DFT methodology.

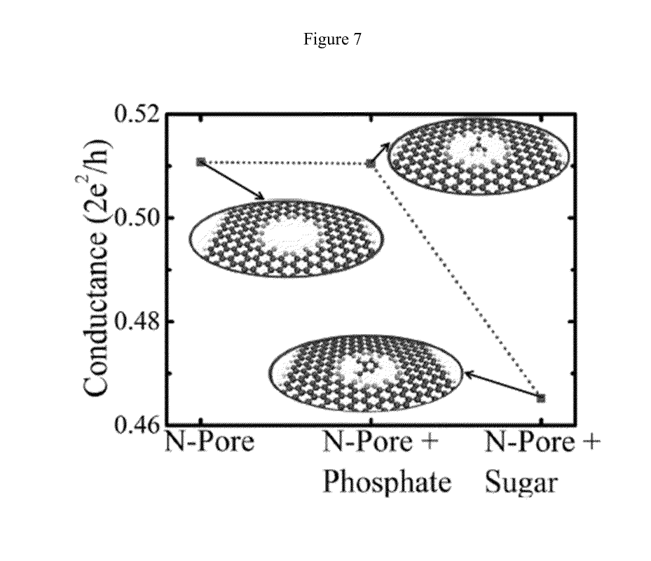

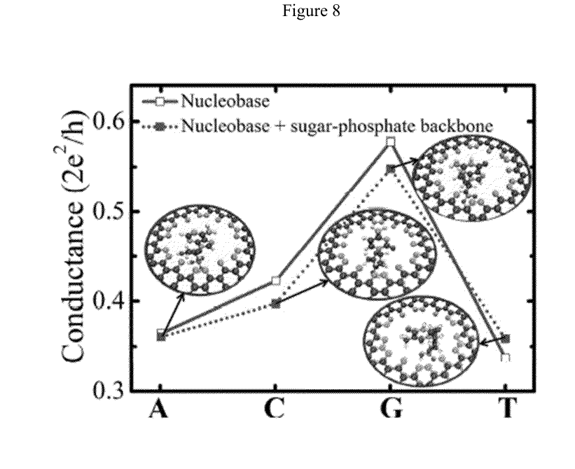

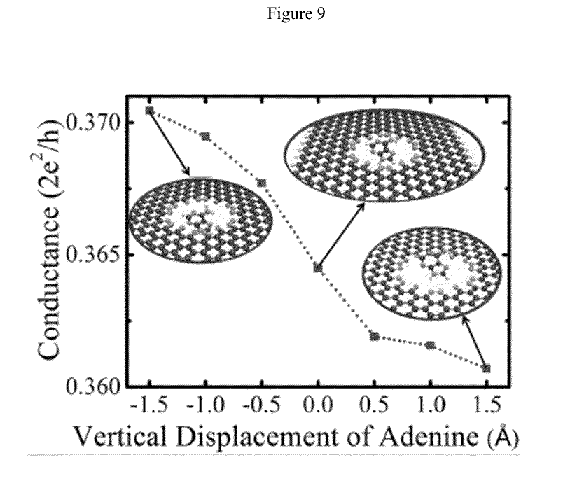

Phosphate and sugar groups comprising the DNA backbone will be adjacent to the nucleobase within the nanopore and may affect the modulation of edge currents. These factors will manifest only as the small noise on the top of large operating current in the disclosed devices. This is confirmed by examining some of the secondary effects in FIGS. 7, 8, and 9. These figures show changes in the conductance of the ZGNR+N-pore biosensor when: (i) isolated sugar or phosphate group is inserted in the nanopore (FIG. 7); (ii) nucleobases are attached to sugar-phosphate backbone (FIG. 8); and (iii) nucleobase is translated vertically above or below the nanopore (FIG. 9). In all three cases, the conductance change is small (S 10%) and certainly enclosed by the intervals delineated in FIG. 3(a).

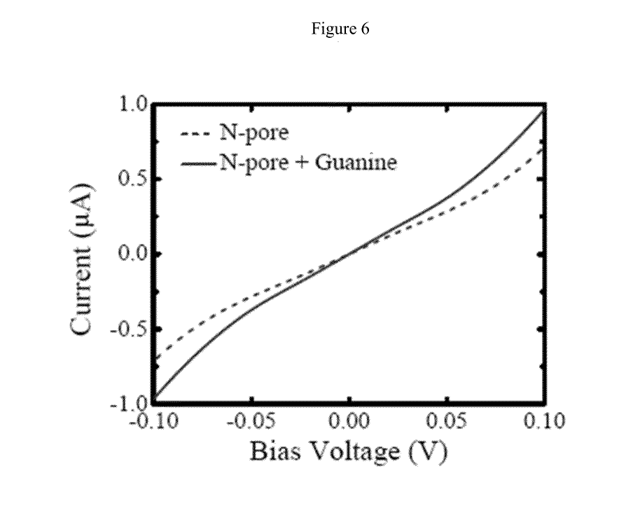

FIG. 6 presents an exemplary range of operating bias voltages that ensures a linear-response regime for one embodiment of the disclosed sensors, in which the measured current is given simply by multiplying conductances in FIG. 2 and FIG. 3 by the bias voltage. Both current-voltage characteristics in FIG. 6, computed for a biosensor with an empty N-pore and the same pore containing guanine, behave essentially linearly within the interval between appx. −0.05 V to about appx. 0.05 V.

Using first-principles quantum transport simulations, graphene nanopore-based sensors for rapid DNA sequencing were investigated, which sensors rely on DNA base-specific modulation of a large transverse conduction current (of the order of μ A at bias volt-age of about 0.1 V). This may be achieved by exploiting unique features of the electronic transport through graphene nanoribbons with zigzag edges where local current density is confined mostly around the nanoribbon edges. Other candidate nanowires that carry edge currents include chiral GNRs. A nanopore at the interior of the GNR cannot substantially diminish the edge currents, whose magnitude is then modulated by the passage of nucleobases in the course of DNA translocation through the pore. The disclosed analysis demonstrates that each DNA base will generate a unique modulation of the charge density and the corresponding electrostatic potential in the surrounding area.

The operating current, which is several orders of magnitude greater than the tunneling current employed in previously considered biosensors with transverse electron transport is larger than its fluctuations due to thermal vibrations of the graphene membrane, structural fluctuations of the translocated DNA molecule and dynamical environment (counterions and water molecules) influence on the electronic structure of nucleotides in solution. The device remains in the linear-response regime for bias voltages of less than or equal to about 0.05 V. The comparatively large ˜1 μA operating current allows measurements of conductance fluctuations with off-the-shelf amplifiers at a rate commensurate with DNA translocation, which may reduce the need to slow down or constrain the DNA molecule as it translocates.

Without being bound to any particular theory, if the current were flowing through the interior of the wire before the pore was drilled, then after the pore were formed most of the current would be blocked. In the disclosed devices, however, because current flows around the edge (due to quantum-mechanical properties of the nanoribbon) of the grapheme, the current is essentially largely unaffected by the presence of the pore (there is a is slight reduction because a small current flows through the interior). These edge currents are, however, much larger than the tunneling currents one may obtain between two gold electrodes separated by vacuum or two carbon nanotubes, as discussed in U.S. Pat. No. 6,905,586.

In the instance of tunneling current, the current may, in some embodiments, be in the range of only around pico- or nano-amps. Smalls change in geometry can affects such current such that noise (fluctuations of current as DNA is moving through a pore) is comparatively large relative to the signal (current itself).

In the present disclosure, the bare current (nanoribbon without or with nanoribbon) is already comparatively large, so inserting DNA changes that large current without also causing fluctuations on the top of something large Put another way, existing technologies operate devices at pico- or nanoamp levels, whereas the disclosed devices operate at microA current which is 1,000,000 to 1,000 times larger signal. The grapheme nanoribbons need not be much wider than the nanopores drilled therein.

With specific reference to FIGS. 7 and 8, these figures illustrate how the presence of sugar and phosphate components of the DNA backbone affects the transverse edge current in two-terminal ZGNR with ≈1.2 nm diameter nanopore whose edge carbon atoms are passivated by nitrogen (N-pore). FIG. 9 shows changes in the conductance of a ZGNR+N-pore biosensor when Adenine is displaced in small steps along the z-axis (which is orthogonal to the plane of the device, see FIG. 1) above and below the nanopore. The DNA backbone is comprised of the sugar 2′-deoxyribose and a neutral phosphate group.

FIGS. 7-9 illustrate that these effects can change the linear-response conductance associated with individual nucleobases (FIGS. 2 and 3), but only by a very small amount (less than or equal to about 10%). Thus, fluctuations of this type in the measured signal are already encompassed by the boundaries of intervals in FIG. 3(a) set by the position of the nucleobases themselves with respect to the nanopore.

What is claimed:

1. An analytic device, comprising:
a first graphene sheet having a first pore formed therethrough,
the first graphene sheet having an edge at a distance from the first pore, the edge including at least one non-linear portion, and
the first graphene sheet being in electronic communication with at least two electrodes.

2. The analytic device of claim 1, wherein at least one atom of the first pore of the first graphene sheet is passivated with a first passivating atom capable of an electronic interaction with a nucleotide base.

3. The analytic device of claim 1, wherein the at least one atom defining the first pore of the first graphene sheet is passivated with hydrogen, nitrogen, or any combination thereof.

4. The analytic device of claim 1, wherein the first graphene sheet is one atom thick.

5. The analytic device of claim 1, wherein the non-linear portion of the edge comprises an indentation, a cut-out, or any combination thereof.

6. The analytic device of claim 5, wherein the non-linear portion is characterized as zig-zagged.

7. The analytic device of claim 1, wherein the edge is located at least 1 atom away from the first pore.

8. The analytic device of claim 7, wherein the edge is located at least 5 atoms away from the first pore.

9. The analytic device of claim 1, wherein the edge is located from between 1 to about 1,000,000 atoms from the first pore.

10. The analytic device of claim 1, wherein the at least two electrodes are configured to drive a current transverse to the first graphene sheet.

11. The analytic device of claim 1, wherein at least one of the electrodes is in electronic communication with a current monitor, a voltage monitor, or both.

12. The analytic device of claim 1, further comprising a voltage source capable of applying a voltage in the range of from 0.05 to about 1 V between the electrodes.

13. The analytic device of claim 1, wherein the first pore places two reservoirs in fluid communication with one another.

14. The analytic device of claim 1, further comprising a device capable of supplying or removing heat from the first graphene membrane.

15. The analytic device of claim 1, further comprising a second pore formed in the first graphene membrane.

16. The analytic device of claim 15, wherein at least one atom defining the second pore of the first graphene sheet is passivated with hydrogen, nitrogen, or any combination thereof.

17. The analytic device of claim 16, wherein atoms of the first and second pores are passivated with different passivating atoms.

18. The analytic device of claim 1, further comprising a second graphene sheet having a second pore formed therethrough, at least one atom of the edge defining the second pore being passivated with hydrogen, nitrogen, or any combination thereof.

19. The analytic device of claim 1, the device being configured to collect a signal related to passage of at least a portion of a macromolecule through the first pore.

20. The analytic device of claim 15, the device being configured to collect a signal related to passage of at least a portion of a macromolecule through the second pore.

21. The analytic device of claim 18, the device being configured to collect a signal related to passage of at least a portion of a macromolecule through the second pore.

22. A method, comprising:
translocating at least a portion of a macromolecule through a first pore formed in a graphene sheet,
at least one atom of the first pore being passivated with a first passivating atom,
the graphene sheet having an edge at a distance from the first pore, the edge including at least one non-linear portion;
collecting at least one signal related to the translocation of the at least a portion of the macromolecule through the first pore.

23. The method of claim 22, wherein the translocation is effected by application of a voltage gradient.

24. The method of claim 22, wherein the macromolecule comprises a polynucleotide.

25. The method of claim 22, wherein the signal is related to an interaction between a base of the polynucleotide and a passivating atom of the first pore.

26. The method of claim 22, further comprising translocating at least a portion of a macromolecule through a second pore formed in the graphene sheet and collecting a signal related to the translocation of the at least a portion of the macromolecule through the second pore.

27. The method of claim 26, wherein the second pore is passivated with an atom that differs from the atom that passivates the first pore.

28. The method of claim 22, further comprising translocating at least a portion of a macromolecule through a second pore formed in a second graphene sheet and collecting a signal related to the translocation of the at least a portion of the macromolecule through the second pore.

29. The method of claim 28, wherein the second graphene sheet comprises an edge at a distance from the first pore, the edge including at least one non-linear portion.

30. The method of claim 28, wherein the second pore is passivated with an atom that differs from the atom that passivates the first pore.

31. A device, comprising:
a first graphene sheet having a first pore formed therethrough,
the first graphene sheet having an edge that comprises chiral graphene, armchair graphene, or both, the edge at a distance from the first pore, and
the first graphene sheet being in electronic communication with at least two electrodes.
